(19) United States
(12) Patent Application Publication
(10) Pub. No.: US 2024/0365063 A1
(43) Pub. Date: Oct. 31, 2024

(54) CROSSTALK CANCELLATION FOR INWARD-FACING TRANSAURAL LOUDSPEAKER SYSTEMS

(71) Applicant: Boomcloud 360 Inc., Encinitas, CA (US)

(72) Inventors: Zachary Seldess, San Diego, CA (US); Joseph Mariglio, Encinitas, CA (US)

(21) Appl. No.: 18/771,711

(22) Filed: Jul. 12, 2024

Related U.S. Application Data
(63) Continuation of application No. 18/144,575, filed on May 8, 2023, now Pat. No. 12,069,454.
Application No. 18/144,575 is a continuation of application No. 17/544,532, filed on Dec. 7, 2021, now Pat. No. 11,689,855.
Application No. 17/544,532 is a continuation of application No. 16/669,440, filed on Oct. 30, 2019, now Pat. No. 11,218,806.
Application No. 16/669,440 is a continuation of application No. 16/147,308, filed on Sep. 28, 2018, now Pat. No. 10,511,909.
(60) Provisional application No. 62/592,302, filed on Nov. 29, 2017.

(51) Int. Cl. H04R 3/14; H04R 5/02; H04R 5/04; H04S 1/00

(52) U.S. Cl. CPC H04R 3/14; H04R 5/02; H04R 5/04; H04S 1/007; H04S 2400/13

(57) ABSTRACT

Embodiments relate to audio processing for opposite facing speaker configurations that results in multiple optimal listening regions around the speakers. A system includes a left speaker and a right speaker in an opposite facing speaker configuration, and a crosstalk cancellation processor connected with the left speaker and the right speaker. The crosstalk cancellation processor applies a crosstalk cancellation to an input audio signal to generate left and right output channels. The left output channel is provided to the left speaker and the right output channel is provided to the right speaker to generate sound including multiple crosstalk cancelled listening regions that are spaced apart.

### CROSS REFERENCE TO RELATED APPLICATION

This application is a continuation of U.S. Non-Provisional patent application Ser. No. 18/144,575, filed on May 8, 2023, which is a continuation of U.S. Non-Provisional patent application Ser. No. 17/544,532, filed on Dec. 7, 2021, which is a continuation of U.S. Non-Provisional patent application Ser. No. 16/669,440, (now U.S. Pat. No. 11,218,806), filed on Oct. 30, 2019, which is a continuation of U.S. Non-Provisional patent application Ser. No. 16/147,308, (now U.S. Pat. No. 10,511,909), filed Sep. 28, 2018, which claims the benefit of U.S. Provisional Application No. 62/592,302, filed Nov. 29, 2017, all the foregoing are incorporated by reference in their entirety.

### TECHNICAL FIELD

The subject matter described herein relates to audio processing, and more particularly to crosstalk cancellation for opposite facing speaker configurations.

### BACKGROUND

Stereophonic sound reproduction involves encoding and reproducing signals containing spatial properties of a sound field using two or more loudspeakers. Stereophonic sound enables a listener to perceive a spatial sense in the sound field. In a typical stereophonic sound reproduction system, two “in field” loudspeakers positioned at fixed locations in the listening field convert a stereo signal into sound waves. The sound waves from each in field loudspeaker propagate through space towards both ears of a listener at an optimal listening region to create an impression of sound heard from various directions within the sound field. However, stereophonic sound reproduction results in one optimal listening region which is unsuitable for multiple listeners at different locations, or fails to accommodate listener movement.

### SUMMARY

Embodiments relate to audio processing for opposite facing speaker configurations that results in multiple optimal listening regions (also referred to as “crosstalk cancelled listening regions”) around the speakers. A system includes a left speaker and a right speaker in an opposite facing speaker configuration, and a crosstalk cancellation processor connected with the left speaker and the right speaker. The crosstalk cancellation processor is configured to: separate a left channel of the input audio signal into a left inband signal and a left out-of-band signal; separate a right channel of the input audio signal into a right inband signal and a right out-of-band signal; generate a left crosstalk cancellation component by filtering and time delaying the left inband signal; generate a right crosstalk cancellation component by filtering and time delaying the right inband signal; generate a left output channel by combining the right crosstalk cancellation component with the left inband signal and the left out-of-band signal; generate a right output channel by combining the left crosstalk cancellation component with the right inband signal and the right out-of-band signal; and provide the left output channel to a left speaker and the right output channel to a right speaker to generate sound including a plurality of crosstalk cancelled listening regions that are spaced apart.

In some embodiments, the plurality of crosstalk cancelled listening regions include a first crosstalk cancelled listening region separated from a second crosstalk cancelled listening region by a mono fill region.

In some embodiments, the left speaker and the right speaker in the opposite facing speaker configuration includes the left speaker and right speaker being addressing outward with respect to each other.

In some embodiments, the left speaker and the right speaker in the opposite facing speaker configuration includes the left speaker and right speaker being spaced apart and addressing inward with respect to each other.

In some embodiments, the crosstalk cancellation processor is further configured to provide the left output channel to another left speaker and the right output channel to another right speaker. The left speaker and the other left speaker address outward with respect to each other and form a left speaker pair. The right speaker and the other right speaker address outward with respect to each other and form a right speaker pair. The left speaker pair and right speaker pair are spaced apart with the left speaker and the right speaker addressing inward with respect to each other

Some embodiments include a non-transitory computer readable medium storing instructions that, when executed by one or more processors (“processor”), configures the processor to: separate a left channel of an input audio signal into a left inband signal and a left out-of-band signal; separate a right channel of the input audio signal into a right inband signal and a right out-of-band signal; generate a left crosstalk cancellation component by filtering and time delaying the left inband signal; generate a right crosstalk cancellation component by filtering and time delaying the right inband signal; generate a left output channel by combining the right crosstalk cancellation component with the left inband signal and the left out-of-band signal; generate a right output channel by combining the left crosstalk cancellation component with the right inband signal and the right out-of-band signal; and provide the left output channel to a left speaker and the right output channel to a right speaker to generate sound. The left speaker and the right speaker are in an opposite facing speaker configuration such that the sound provides a plurality of crosstalk cancelled listening regions that are spaced apart.

Some embodiments include a method for processing an input audio signal, including: separating a left channel of the input audio signal into a left inband signal and a left out-of-band signal; separating a right channel of the input audio signal into a right inband signal and a right out-of-band signal; generating a left crosstalk cancellation component by filtering and time delaying the left inband signal; generating a right crosstalk cancellation component by filtering and time delaying the right inband signal; generating a left output channel by combining the right crosstalk cancellation component with the left inband signal and the left out-of-band signal; generating a right output channel by combining the left crosstalk cancellation component with the right inband signal and the right out-of-band signal; and providing the left output channel to a left speaker and the right output channel to a right speaker to generate sound. The left speaker and the right speaker are in an opposite facing speaker configuration such that the sound provides a plurality of crosstalk cancelled listening regions that are spaced apart

### BRIEF DESCRIPTION OF THE DRAWINGS

Figures (FIGS. 1A, 1B, and 1C are examples of opposite facing speaker configurations, in accordance with some embodiments.

Figure (FIG. 2 is a schematic block diagram of an audio processing system, in accordance with some embodiments.

FIG. 3 is a schematic block diagram of a subband spatial processor, in accordance with some embodiments.

FIG. 4 is a schematic block diagram of a crosstalk compensation processor, in accordance with some embodiments.

FIG. 5 is a schematic block diagram of a crosstalk cancellation processor, in accordance with some embodiments.

FIG. 6 is a flow chart of a process for performing subband spatial enhancement and crosstalk cancellation on an input audio signal for opposite facing speakers, in accordance with some embodiments.

FIG. 7 is a flow chart of a process for performing crosstalk cancellation on an input audio signal for opposite facing speakers, in accordance with some embodiments.

FIG. 8 is a schematic block diagram of a computer system, in accordance with some embodiments.

The figures depict, and the detail description describes, various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to audio processing with crosstalk cancellation for opposite facing speaker configurations. Crosstalk cancellation blends a phase-inverted, filtered and delayed version of a contralateral signal with an ipsilateral signal over trans-aural loudspeakers. Crosstalk cancellation may be described as defined in Equation 1:

$$L ≡ {T}_{i} + {T}_{c} = ( {A}_{i} * {x}_{i} ) + {A}_{c} * {x}_{c} * {z}^{- δ} \qquad Eq . ( 1 )$$

where Ai and Ac are delay-canonical matrices applying the ipsolateral and contralateral filters, respectively, z^{-δ} is a delay operator where δ is the delay in (possibly fractional) samples to be applied to the contralateral signal, Ti and Tc are the transformed ipsilateral and contralateral signals, and xi and xc are the input ipsilateral and contralateral signals.

An “opposite facing speaker configuration” refers to multiple (e.g., left and right stereo) speakers that are located at an angle of 180° from each other. FIGS. 1A, 1B, and 1C are examples of opposite facing speaker configurations, in accordance with some embodiments. With reference to FIG. 1A, the speakers 110_{L} and 110_{R} are placed in proximity and oriented with speakers addressing outward, away from each other. With reference to FIG. 1B, the speakers 112_{L} and 112_{R} are spaced apart by a distance dₛ and are oriented with speakers addressing inward, toward each other. With reference to FIG. 1C, the speakers 114_{L} and 116_{L} form a left speaker pair, and the speakers 114_{R} and 116_{R} form a right speaker pair. Like the speakers 110_{L} and 110_{R} shown in FIG. 1A, the speakers 114_{L} and 116_{L} address outward with respect to each other. Similarly, the speakers 114_{R} and 116_{R} address outward with respect to each other. Like the speakers 112_{L} and 112_{R} shown in FIG. 1B, the left speaker pair and the right speaker pair are separated by a distance dₛ with respect to the speaker 114_{R} of the right speaker pair, and the speakers 116_{L} and 114_{R} address inward with respect to the each other.

With proper tuning, crosstalk cancellation (CTC) processing on an input audio signal for stereo speakers may be performed to generate a stereo output signal for speakers in the opposite facing speaker configuration of FIG. 1A, 1B, or 1C. The output signal when reproduced by the speakers provides dramatic spatial impressions from multiple ideal listening locations, and a consistent fill from everywhere else.

For example, each of the opposite facing speaker configurations of FIGS. 1A, 1B, and 1C results in two optimal listening regions 180, centered at θᵤ=0 (e.g., as shown by the listener 140a) and θᵤ=π (e.g., as shown by the listener 140a), relative to the front of the speaker array. The mono fill regions 182 are centered at θᵤ=π/2 and (e.g., as shown by the listener 140b) and θᵤ=(3π)/2. In transition zones defined between optimal listening regions 180 and mono fill regions 182, a gradual collapse of the soundstage and transition to mono fill is perceived.

If the speakers exhibit a pattern ranging from omni to cardioid (i.e. no polarity inversion at π radians), as shown in FIGS. 1A, 1B, and 1C, and the housing is constructed to minimize structure- and air-borne coupling, a single-path CTC processing can cancel much of the crosstalk in the optimal listening regions 180. In particular, the CTC processing models off-axis radiation effects. Furthermore, because each speaker would effectively be presenting a combination of the left and right signals as a result of the CTC processing, in points that lie outside of the optimal listening region 180, the spatial effect is replaced with a consistent mono fill.

A related class of speaker configurations may be constructed with the speakers at angles less than 180°, for example, between 30° and 180°. In this case, one of the two optimal listening locations would have privileged status due to the crispness of its imaging, whereas the soundstage presented to the secondary optimal listening location would be somewhat less sharply defined.

### Example Audio Processing System

FIG. 2 is a schematic block diagram of an audio processing system 200, in accordance with some embodiments. The system 200 spatially enhances an input audio signal X, and performs crosstalk cancellation on the spatially enhanced audio signal. The system 200 receives an input audio signal X including a left input channel X_{L} and a right input channel X_{R}, and generates an output audio signal O including a left output channel O_{L} and a right output channel O_{R} by processing the input channels X_{L} and X_{R}. Although not shown in FIG. 2, the spatial enhancement processor 222 may further include an amplifier that amplifies the output audio signal O from the crosstalk cancellation processor 260, and provides the signal O to output devices, such as the opposite facing speakers shown in FIGS. 1A through 1C, that convert the output channels X_{L} and X_{R} into sound. For example, the left output channel O_{L} is provided to the left speaker 110_{L}, and the right output channel O_{R} is provided to the right speaker 110_{R} for the opposite facing speaker configuration of FIG. 1A. For the opposite facing speaker configuration of FIG. 1B, the left output channel O_{L} is provided to the left speaker 112_{L}, and the right output channel O_{R} is provided to the right speaker 112_{R}. For the opposite facing speaker configuration of FIG. 1C, the left output channel O_{L} is provided to the left speaker pair including the left speakers 114_{L} and 116_{L}, and the right output channel O_{R} is provided to the right speaker pair including the right speakers 114_{R} and 116_{R}.

The system 200 includes a subband spatial processor 205, a crosstalk compensation processor 240, a combiner 250, and a crosstalk cancellation processor 260. The system 200 performs crosstalk compensation and subband spatial processing of the input channels X_{L} and X_{R}, combines the result of the subband spatial processing with the result of the crosstalk compensation, and then performs a crosstalk cancellation on the combined result.

The subband spatial processor 205 includes a spatial frequency band divider 210, a spatial frequency band processor 220, and a spatial frequency band combiner 230. The spatial frequency band divider 210 is coupled to the input channels X_{L} and X_{R} and the spatial frequency band processor 220. The spatial frequency band divider 210 receives the left input channel X_{L} and the right input channel X_{R}, and processes the input channels into a spatial (or “side”) component Xₛ and a nonspatial (or “mid”) component Xₘ. For example, the spatial component Xₛ can be generated based on a difference between the left input channel X_{L} and the right input channel X_{R}. The nonspatial component Xₘ can be generated based on a sum of the left input channel X_{L} and the right input channel X_{R}. The spatial frequency band divider 210 provides the spatial component Xₛ and the nonspatial component Xₘ to the spatial frequency band processor 220.

The spatial frequency band processor 220 is coupled to the spatial frequency band divider 210 and the spatial frequency band combiner 230. The spatial frequency band processor 220 receives the spatial component Xₛ and the nonspatial component Xₘ from spatial frequency band divider 210, and enhances the received signals. In particular, the spatial frequency band processor 220 generates an enhanced spatial component Eₛ from the spatial component Xₛ, and an enhanced nonspatial component Eₘ from the nonspatial component Xₘ.

For example, the spatial frequency band processor 220 applies subband gains to the spatial component Xₛ to generate the enhanced spatial component Eₛ, and applies subband gains to the nonspatial component Xₘ to generate the enhanced nonspatial component Eₘ. In some embodiments, the spatial frequency band processor 220 additionally or alternatively provides subband delays to the spatial component Xₛ to generate the enhanced spatial component Eₛ, and subband delays to the nonspatial component Xₘ to generate the enhanced nonspatial component Eₘ. The subband gains and/or delays may can be different for the different (e.g., n) subbands of the spatial component Xₛ and the nonspatial component Xₘ, or can be the same (e.g., for two or more subbands). The spatial frequency band processor 220 adjusts the gain and/or delays for different subbands of the spatial component Xₛ and the nonspatial component Xₘ with respect to each other to generate the enhanced spatial component Eₛ and the enhanced nonspatial component Eₘ. The spatial frequency band processor 220 then provides the enhanced spatial component Eₛ and the enhanced nonspatial component Eₘ to the spatial frequency band combiner 230.

The spatial frequency band combiner 230 is coupled to the spatial frequency band processor 220, and further coupled to the combiner 250. The spatial frequency band combiner 230 receives the enhanced spatial component Eₛ and the enhanced nonspatial component Eₘ from the spatial frequency band processor 220, and combines the enhanced spatial component Eₛ and the enhanced nonspatial component Eₘ into a left enhanced channel E_{L} and a right enhanced channel E_{R}. For example, the left enhanced channel E_{L} can be generated based on a sum of the enhanced spatial component Eₛ and the enhanced nonspatial component Eₘ, and the right enhanced channel E_{R} can be generated based on a difference between the enhanced nonspatial component Eₘ and the enhanced spatial component Eₛ. The spatial frequency band combiner 230 provides the left enhanced channel E_{L} and the right enhanced channel E_{R} to the combiner 250.

The crosstalk compensation processor 240 performs a crosstalk compensation to compensate for spectral defects or artifacts in the crosstalk cancellation. The crosstalk compensation processor 240 receives the input channels X_{L} and X_{R}, and performs a processing to compensate for any artifacts in a subsequent crosstalk cancellation of the enhanced nonspatial component Eₘ and the enhanced spatial component Eₛ performed by the crosstalk cancellation processor 260. In some embodiments, the crosstalk compensation processor 240 may perform an enhancement on the nonspatial component Xₘ and the spatial component Xₛ by applying filters to generate a crosstalk compensation signal Z, including a left crosstalk compensation channel Z_{L} and a right crosstalk compensation channel Z_{R,In} other embodiments, the crosstalk compensation processor 240 may perform an enhancement on only the nonspatial component Xₘ.

The combiner 250 combines the left enhanced channel E_{L} with the left crosstalk compensation channel Z_{L} to generate a left enhanced compensated channel T_{L}, and combines the right enhanced channel E_{R} with the right crosstalk compensation channel Z_{R} to generate a right compensation channel T_{R}. The combiner 250 is coupled to the crosstalk cancellation processor 260, and provides the left enhanced compensated channel T_{L} and the right enhanced compensation channel T_{R} to the crosstalk cancellation processor 260.

The crosstalk cancellation processor 260 receives the left enhanced compensated channel T_{L} and the right enhanced compensation channel T_{R}, and performs crosstalk cancellation on the channels T_{L}, T_{R} to generate the output audio signal O including the left output channel O_{L} and the right output channel O_{R}.

In some embodiments, the subband spatial processor 205 of the audio processing system 200 may be disabled or operate as a bypass. The audio processing system 200 applies crosstalk cancellation without the spatial enhancement. In some embodiments, the subband spatial processor 205 is omitted from the system 200. The combiner 250 is coupled to the input channels X_{L} and X_{R} instead of the output of the subband spatial processor 205, and combines the input channels X_{L} and X_{R} with the left crosstalk compensation channel Z_{L} and the right crosstalk compensation channel Z_{R} to generate a compensated signal T including the channels T_{L} and T_{R}. The crosstalk cancellation processor 260 applies crosstalk cancellation on the compensated signal T to generate the output signal O including the output channels O_{L} and O_{R}.

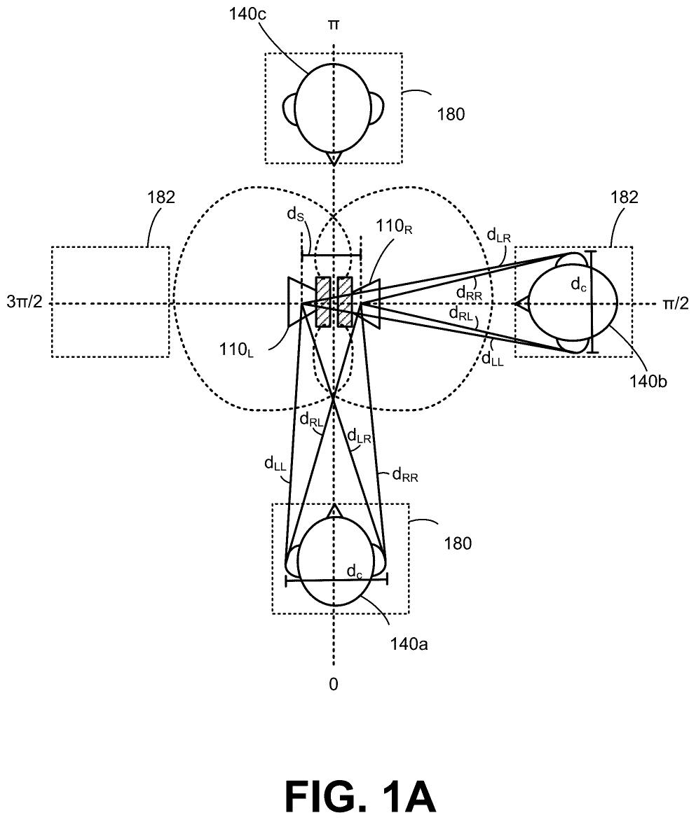

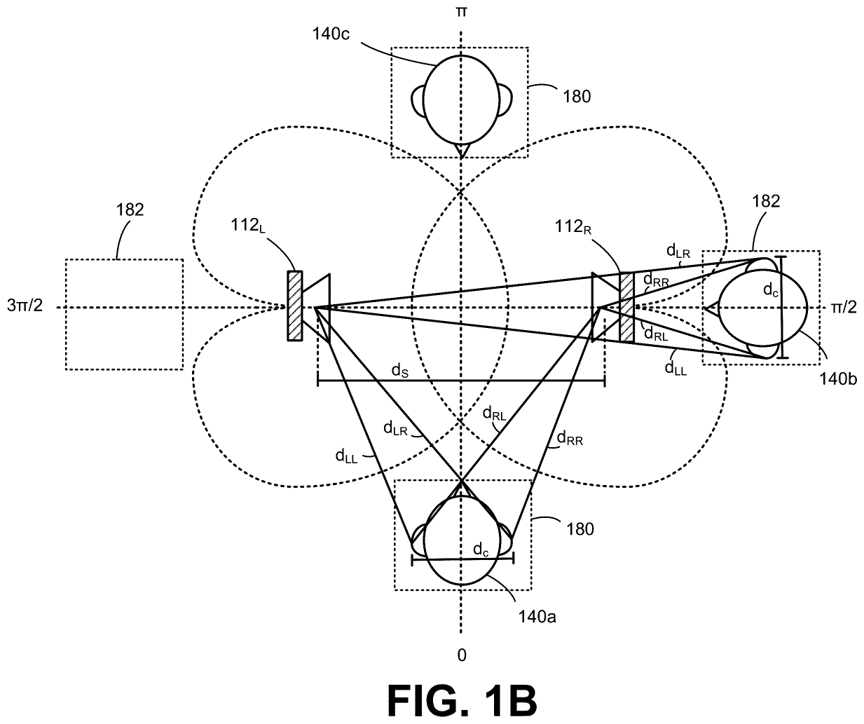

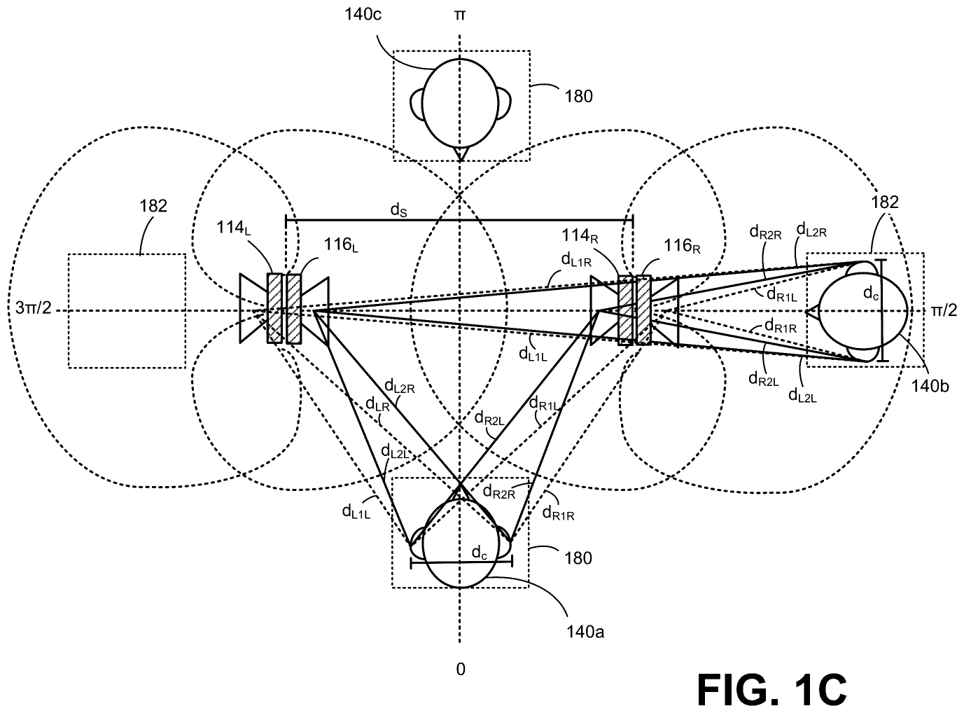

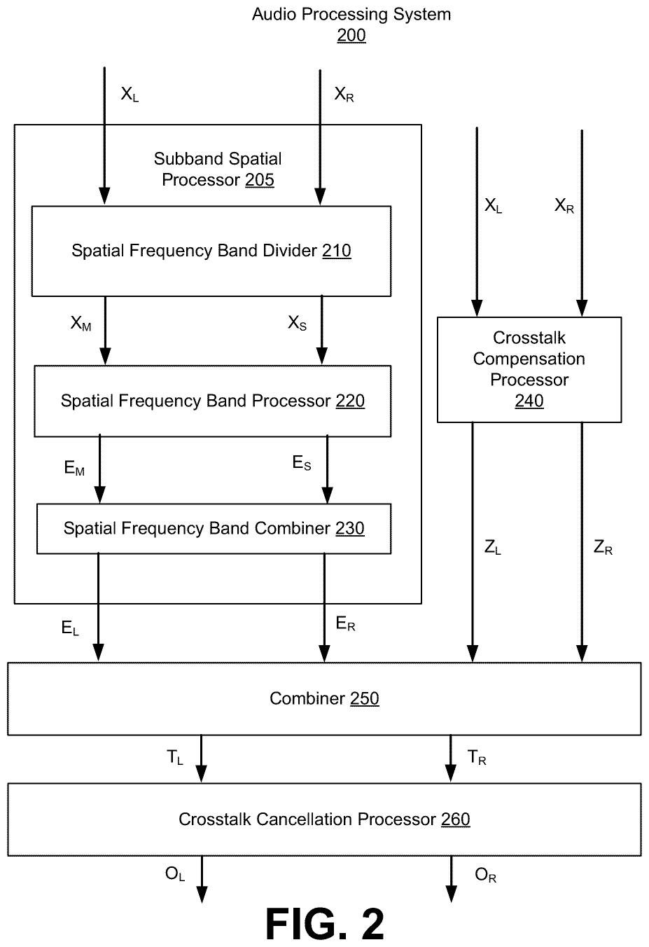

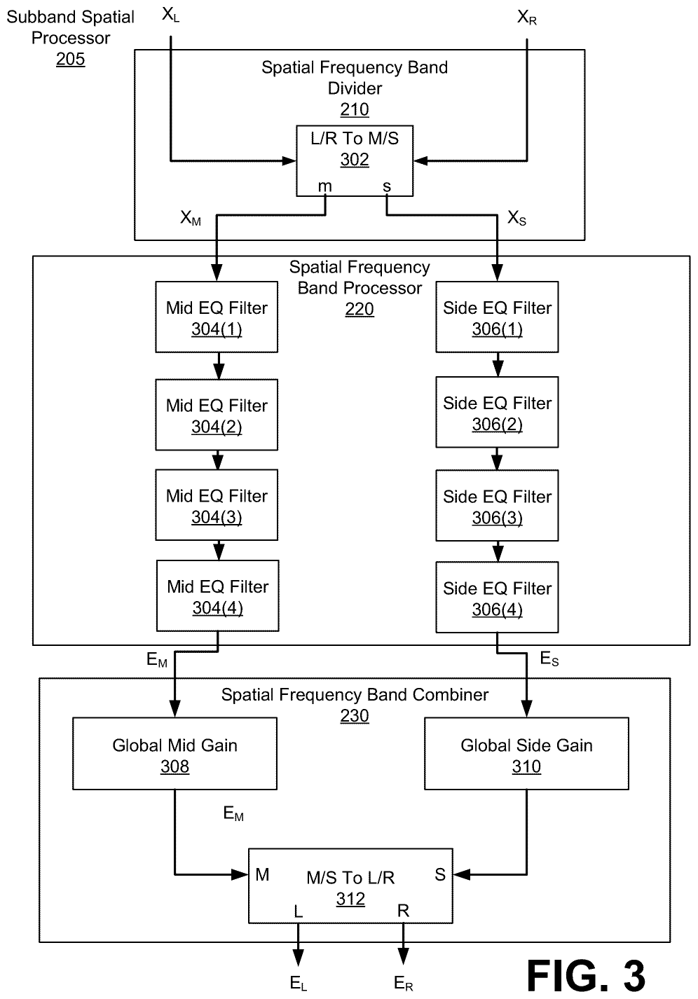

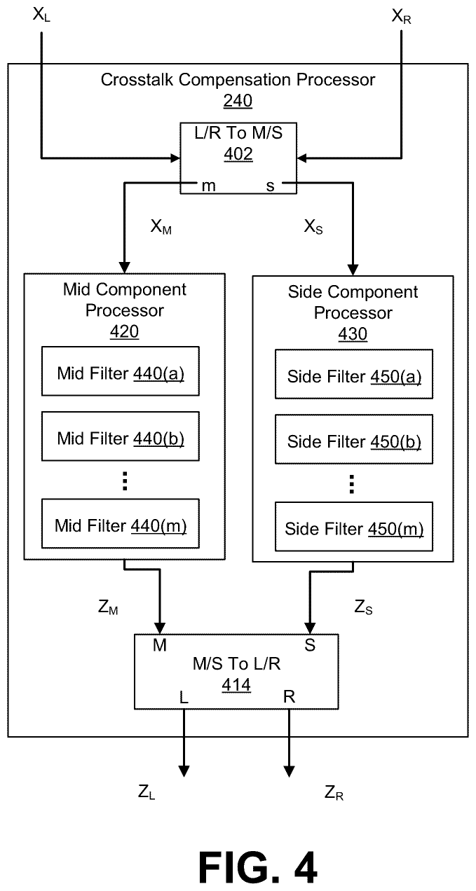

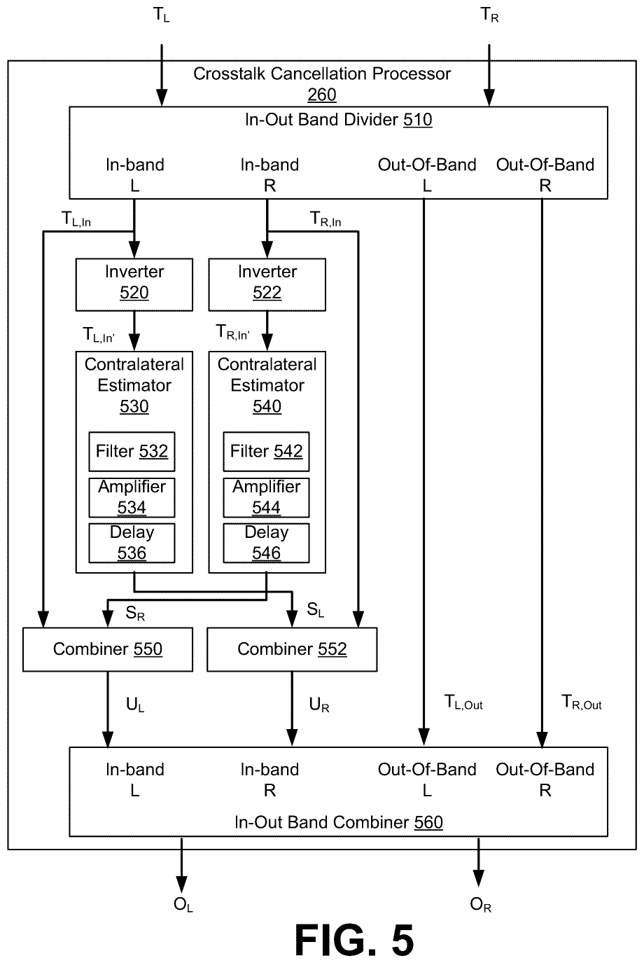

Additional details regarding the subband spatial processor 205 are discussed below in connection with FIG. 3, additional details regarding the crosstalk compensation processors 240 are discussed below in connection with FIG. 4, and additional details regarding the crosstalk cancellation processor 260 are discussed below in connection with FIG. 5.

### Example Subband Spatial Processor

FIG. 3 is a schematic block diagram of a subband spatial processor 205, in accordance with some embodiments. The subband spatial processor 205 includes the spatial frequency band divider 210, the spatial frequency band processor 220, and the spatial frequency band combiner 230. The spatial frequency band divider 210 is coupled to the spatial frequency band processor 220, and the spatial frequency band processor 220 is coupled to the spatial frequency band combiner 230.

The spatial frequency band divider 210 includes an L/R to M/S converter 302 that receives the left input channel X_{L} and a right input channel X_{R}, and converts these inputs into the spatial component Xₘ and the nonspatial component Xₛ. The spatial component Xₛ may be generated by subtracting the left input channel X_{L} and right input channel X_{R}. The nonspatial component Xₘ may be generated by adding the left input channel X_{L} and the right input channel X_{R}.

The spatial frequency band processor 220 receives the nonspatial component Xₘ and applies a set of subband filters to generate the enhanced nonspatial subband component Eₘ. The spatial frequency band processor 220 also receives the spatial subband component Xₛ and applies a set of subband filters to generate the enhanced nonspatial subband component Eₘ. The subband filters can include various combinations of peak filters, notch filters, low pass filters, high pass filters, low shelf filters, high shelf filters, bandpass filters, bandstop filters, and/or all pass filters.

In some embodiments, the spatial frequency band processor 220 includes a subband filter for each of n frequency subbands of the nonspatial component Xₘ and a subband filter for each of the n frequency subbands of the spatial component Xₛ. For n=4 subbands, for example, the spatial frequency band processor 220 includes a series of subband filters for the nonspatial component Xₘ including a mid equalization (EQ) filter 304(1) for the subband (1), a mid EQ filter 304(2) for the subband (2), a mid EQ filter 304(3) for the subband (3), and a mid EQ filter 304(4) for the subband (4). Each mid EQ filter 304 applies a filter to a frequency subband portion of the nonspatial component Xₘ to generate the enhanced nonspatial component Eₘ.

The spatial frequency band processor 220 further includes a series of subband filters for the frequency subbands of the spatial component Xₛ, including a side equalization (EQ) filter 306(1) for the subband (1), a side EQ filter 306(2) for the subband (2), a side EQ filter 306(3) for the subband (3), and a side EQ filter 306(4) for the subband (4). Each side EQ filter 306 applies a filter to a frequency subband portion of the spatial component Xₛ to generate the enhanced spatial component Eₛ.

Each of the n frequency subbands of the nonspatial component Xₘ and the spatial component Xₛ may correspond with a range of frequencies. For example, the frequency subband (1) may corresponding to 0 to 300 Hz, the frequency subband (2) may correspond to 300 to 510 Hz, the frequency subband (3) may correspond to 510 to 2700 Hz, and the frequency subband (4) may correspond to 2700 Hz to Nyquist frequency. In some embodiments, the n frequency subbands are a consolidated set of critical bands. The critical bands may be determined using a corpus of audio samples from a wide variety of musical genres. A long term average energy ratio of mid to side components over the 24 Bark scale critical bands is determined from the samples. Contiguous frequency bands with similar long term average ratios are then grouped together to form the set of critical bands. The range of the frequency subbands, as well as the number of frequency subbands, may be adjustable.

In some embodiments, the mid EQ filters 304 or side EQ filters 306 may include a biquad filter, having a transfer function defined by Equation 2:

$$H ( z ) = \frac{{b}_{0} + {b}_{1} {z}^{- 1} + {b}_{2} {z}^{- 2}}{{a}_{0} + {a}_{1} {z}^{- 1} + {a}_{2} {z}^{- 2}} \qquad Eq . ( 2 )$$

where z is a complex variable. The filter may be implemented using a direct form I topology as defined by Equation 3:

$$Y [ n ] = \frac{{b}_{0}}{{a}_{0}} X [ n - 1 ] + \frac{{b}_{1}}{{a}_{0}} X [ n - 1 ] + \frac{{b}_{2}}{{a}_{0}} X [ n - 2 ] - \frac{{a}_{1}}{{a}_{0}} Y [ n - 1 ] - \frac{{a}_{2}}{{a}_{0}} Y [ n - 2 ] \qquad Eq . ( 3 )$$

where X is the input vector, and Y is the output. Other topologies might have benefits for certain processors, depending on their maximum word-length and saturation behaviors.

The biquad can then be used to implement any second-order filter with real-valued inputs and outputs. To design a discrete-time filter, a continuous-time filter is designed and transformed it into discrete time via a bilinear transform. Furthermore, compensation for any resulting shifts in center frequency and bandwidth may be achieved using frequency warping.

For example, a peaking filter may include an S-plane transfer function defined by Equation 4:

$$H ( s ) = \frac{{s}^{2} + s ( A / Q ) + 1}{{s}^{2} + s ( A / Q ) + 1} \qquad Eq . ( 4 )$$

where s is a complex variable, A is the amplitude of the peak, and Q is the filter “quality” (canonically derived as:

$$Q = \frac{{f}_{c}}{Δ f} ) .$$

The digital filters coefficients are:

$${b}_{0} = 1 + α A$$

$${b}_{1} = - 2 * cos ( {ω}_{0} )$$

$${b}_{2} = 1 - α A$$

$${a}_{0} = 1 + \frac{α}{A}$$

$${a}_{1} = - 2 cos ( {ω}_{0} )$$

$${a}_{2} = 1 + \frac{α}{A}$$

$$α = \frac{sin ( {ω}_{0} )}{2 Q} .$$

where ω₀ is the center frequency of the filter in radians and

The spatial frequency band combiner 230 receives mid and side components, applies gains to each of the components, and converts the mid and side components into left and right channels. For example, the spatial frequency band combiner 230 receives the enhanced nonspatial component Eₘ and the enhanced spatial component Eₛ, and performs global mid and side gains before converting the enhanced nonspatial component Eₘ and the enhanced spatial component Eₛ into the left spatially enhanced channel E_{L} and the right spatially enhanced channel E_{R}.

More specifically, the spatial frequency band combiner 230 includes a global mid gain 308, a global side gain 310, and an M/S to L/R converter 312 coupled to the global mid gain 308 and the global side gain 310. The global mid gain 308 receives the enhanced nonspatial component Eₘ and applies a gain, and the global side gain 310 receives the enhanced spatial component Eₛ and applies a gain. The M/S to L/R converter 312 receives the enhanced nonspatial component Eₘ from the global mid gain 308 and the enhanced spatial component Eₛ from the global side gain 310, and converts these inputs into the left enhanced channel E_{L} and the right enhanced channel E_{R}.

FIG. 4 is a schematic block diagram of a crosstalk compensation processor 240, in accordance with some embodiments. The crosstalk compensation processor 240 receives left and right input channels X_{L} and X_{R}, and generates left and right output channels by applying a crosstalk compensation on the input channels. The crosstalk compensation processer 240 includes a L/R to M/S converter 402, a mid component processor 420, a side component processor 430, and an M/S to L/R converter 414.

The crosstalk compensation processor 240 receives the input channels HF_{L} and HF_{R}, and performs a preprocessing to generate the left crosstalk compensation channel Z_{L} and the right crosstalk compensation channel Z_{R}. The channels Z_{L}, Z_{R} may be used to compensate for any artifacts in crosstalk processing, such as crosstalk cancellation. The L/R to M/S converter 402 receives the left channel X_{L} and the right channel X_{R}, and generates the nonspatial component Xₘ and the spatial component Xₛ of the input channels X_{L}, X_{R}. The left and right channels may be summed to generate the nonspatial component of the left and right channels, and subtracted to generate the spatial component of the left and right channels.

The mid component processor 420 includes a plurality of filters 440, such as m mid filters 440 (a), 440 (b), through 440(m). Here, each of the m mid filters 440 processes one of m frequency bands of the nonspatial component Xₘ and the spatial component Xₛ. The mid component processor 420 generates a mid crosstalk compensation channel Zₘ by processing the nonspatial component Xₘ. In some embodiments, the mid filters 440 are configured using a frequency response plot of the nonspatial Xₘ with crosstalk processing through simulation. In addition, by analyzing the frequency response plot, any spectral defects such as peaks or troughs in the frequency response plot over a predetermined threshold (e.g., 10 dB) occurring as an artifact of the crosstalk processing can be estimated. These artifacts result primarily from the summation of the delayed and inverted contralateral signals with their corresponding ipsilateral signal in the crosstalk processing, thereby effectively introducing a comb filter-like frequency response to the final rendered result. The mid crosstalk compensation channel Zₘ can be generated by the mid component processor 420 to compensate for the estimated peaks or troughs, where each of the m frequency bands corresponds with a peak or trough. Specifically, based on the specific delay, filtering frequency, and gain applied in the crosstalk processing, peaks and troughs shift up and down in the frequency response, causing variable amplification and/or attenuation of energy in specific regions of the spectrum. Each of the mid filters 440 may be configured to adjust for one or more of the peaks and troughs.

The side component processor 430 includes a plurality of filters 450, such as m side filters 450 (a), 450 (b) through 450(m). The side component processor 430 generates a side crosstalk compensation channel Zₛ by processing the spatial component Xₛ. In some embodiments, a frequency response plot of the spatial Xₛ with crosstalk processing can be obtained through simulation. By analyzing the frequency response plot, any spectral defects such as peaks or troughs in the frequency response plot over a predetermined threshold (e.g., 10 dB) occurring as an artifact of the crosstalk processing can be estimated. The side crosstalk compensation channel Zₛ can be generated by the side component processor 430 to compensate for the estimated peaks or troughs. Specifically, based on the specific delay, filtering frequency, and gain applied in the crosstalk processing, peaks and troughs shift up and down in the frequency response, causing variable amplification and/or attenuation of energy in specific regions of the spectrum. Each of the side filters 450 may be configured to adjust for one or more of the peaks and troughs. In some embodiments, the mid component processor 420 and the side component processor 430 may include a different number of filters.

In some embodiments, the mid filters 440 and side filters 450 may include a biquad filter having a transfer function defined by Equation 5:

$$H ( z ) = \frac{{b}_{0} + {b}_{1} {z}^{- 1} + {b}_{2} {z}^{- 2}}{{a}_{0} + {a}_{1} {z}^{- 1} + {a}_{2} {z}^{- 2}} \qquad Eq . ( 5 )$$

where z is a complex variable, and a₀, a₁, a₂, b₀, b₁, and b₂ are digital filter coefficients. One way to implement such a filter is the direct form I topology as defined by Equation 6:

$$Y [ n ] = \frac{{b}_{0}}{{a}_{0}} X [ n - 1 ] + \frac{{b}_{1}}{{a}_{0}} X [ n - 1 ] + \frac{{b}_{2}}{{a}_{0}} X [ n - 2 ] - \frac{{a}_{1}}{{a}_{0}} Y [ n - 1 ] - \frac{{a}_{2}}{{a}_{0}} Y [ n - 2 ] \qquad Eq . ( 6 )$$

where X is the input vector, and Y is the ouput. Other topologies may be used, depending on their maximum word-length and saturation behaviors.

The biquad can then be used to implement a second-order filter with real-valued inputs and outputs. To design a discrete-time filter, a continuous-time filter is designed, and then transformed into discrete time via a bilinear transform. Furthermore, resulting shifts in center frequency and bandwidth may be compensated using frequency warping.

For example, a peaking filter may have an S-plane transfer function defined by Equation 7:

$$H ( s ) = \frac{{s}^{2} + s ( A / Q ) + 1}{{s}^{2} + s ( A / Q ) + 1} \qquad Eq . ( 7 )$$

where s is a complex variable, A is the amplitude of the peak, and Q is the filter “quality,” and and the digital filter coefficients are defined by:

$${b}_{0} = 1 + α A$$

$${b}_{1} = - 2 * cos ( {ω}_{0} )$$

$${b}_{2} = 1 - α A$$

$${a}_{0} = 1 + \frac{α}{A}$$

$${a}_{1} = - 2 cos ( {ω}_{0} )$$

$${a}_{2} = 1 + \frac{α}{A}$$

$$α = \frac{sin ( {ω}_{0} )}{2 Q} .$$

where ω₀ is the center frequency of the filter in radians and

Furthermore, the filter quality Q may be defined by Equation 8:

$$Q = \frac{{f}_{c}}{Δ f} \qquad Eq . ( 8 )$$

where Δf is a bandwidth and f_{c} is a center frequency.

The M/S to L/R converter 414 receives the mid crosstalk compensation channel Zₘ and the side crosstalk compensation channel Zₛ, and generates the left crosstalk compensation channel Z_{L} and the right crosstalk compensation channel Z_{R,In} general, the mid and side channels may be summed to generate the left channel of the mid and side components, and the mid and side channels may be subtracted to generate right channel of the mid and side components.

### Example Crosstalk Cancellation Processor

FIG. 5 is a schematic block diagram of a crosstalk cancellation processor 260, in accordance with some embodiments. The crosstalk cancellation processor 260 receives the left enhanced compensation channel T_{L} and the right enhanced compensation channel T_{R} from the combiner 250, and performs crosstalk cancellation on the channels T_{L}, T_{R} to generate the left output channel O_{L}, and the right output channel O_{R}.

The crosstalk cancellation processor 260 includes an in-out band divider 510, inverters 520 and 522, contralateral estimators 530 and 540, combiners 550 and 552, and an in-out band combiner 560. These components operate together to divide the input channels T_{L}, T_{R} into in-band components and out-of-band components, and perform a crosstalk cancellation on the in-band components to generate the output channels O_{L}, O_{R}.

By dividing the input audio signal T into different frequency band components and by performing crosstalk cancellation on selective components (e.g., in-band components), crosstalk cancellation can be performed for a particular frequency band while obviating degradations in other frequency bands. If crosstalk cancellation is performed without dividing the input audio signal T into different frequency bands, the audio signal after such crosstalk cancellation may exhibit significant attenuation or amplification in the nonspatial and spatial components in low frequency (e.g., below 350 Hz), higher frequency (e.g., above 12000 Hz), or both. By selectively performing crosstalk cancellation for the in-band (e.g., between 250 Hz and 14000 Hz), where the vast majority of impactful spatial cues reside, a balanced overall energy, particularly in the nonspatial component, across the spectrum in the mix can be retained.

The in-out band divider 510 separates the input channels T_{L}, T_{R} into in-band channels T_{L,In}, T_{R,In} and out of band channels T_{L,Out}, T_{R,Out}, respectively. Particularly, the in-out band divider 510 divides the left enhanced compensation channel T_{L} into a left in-band channel T_{L,In} and a left out-of-band channel T_{L,Out}. Similarly, the in-out band divider 510 separates the right enhanced compensation channel T_{R} into a right in-band channel T_{R,In} and a right out-of-band channel T_{R,Out}. Each in-band channel may encompass a portion of a respective input channel corresponding to a frequency range including, for example, 250 Hz to 14 kHz. The range of frequency bands may be adjustable, for example according to speaker parameters.

The inverter 520 and the contralateral estimator 530 operate together to generate a left contralateral cancellation component SL to compensate for a contralateral sound component due to the left in-band channel T_{L,In}. Similarly, the inverter 522 and the contralateral estimator 540 operate together to generate a right contralateral cancellation component SR to compensate for a contralateral sound component due to the right in-band channel T_{R,In}.

In one approach, the inverter 520 receives the in-band channel T_{L,In} and inverts a polarity of the received in-band channel T_{L,In} to generate an inverted in-band channel T_{L,In}′. The contralateral estimator 530 receives the inverted in-band channel T_{L,In}′, and extracts a portion of the inverted in-band channel T_{L,In}′ corresponding to a contralateral sound component through filtering. Because the filtering is performed on the inverted in-band channel T_{L,In}′, the portion extracted by the contralateral estimator 530 becomes an inverse of a portion of the in-band channel T_{L,In} attributing to the contralateral sound component. Hence, the portion extracted by the contralateral estimator 530 becomes a left contralateral cancellation component SL, which can be added to a counterpart in-band channel T_{R,In} to reduce the contralateral sound component due to the in-band channel T_{L,In}. In some embodiments, the inverter 520 and the contralateral estimator 530 are implemented in a different sequence.

The inverter 522 and the contralateral estimator 540 perform similar operations with respect to the in-band channel T_{R,In} to generate the right contralateral cancellation component SR. Therefore, detailed description thereof is omitted herein for the sake of brevity.

In one example implementation, the contralateral estimator 530 includes a filter 532, an amplifier 534, and a delay unit 536. The filter 532 receives the inverted input channel T_{L,In}′ and extracts a portion of the inverted in-band channel T_{L,In}′ corresponding to a contralateral sound component through a filtering function. An example filter implementation is a Notch or Highshelf filter with a center frequency selected between 5000 and 10000 Hz, and Q selected between 0.5 and 1.0. Gain in decibels (GdB) may be derived from Equation 9:

$${G}_{dB} = - 3. - {log}_{1.333} ( D ) \qquad Eq . ( 9 )$$

where D is a delay amount by delay unit 536 in samples, for example, at a sampling rate of 48 KHz. An alternate implementation is a Lowpass filter with a corner frequency selected between 5000 and 10000 Hz, and Q selected between 0.5 and 1.0. Moreover, the amplifier 534 amplifies the extracted portion by a corresponding gain coefficient G_{L,In}, and the delay unit 536 delays the amplified output from the amplifier 534 according to a delay function D to generate the left contralateral cancellation component SL. The contralateral estimator 540 includes a filter 542, an amplifier 544, and a delay unit 546 that performs similar operations on the inverted in-band channel T_{R,In}′ to generate the right contralateral cancellation component SR. In one example, the contralateral estimators 530, 540 generate the left contralateral cancellation components SL, SR, according to equations below:

$${S}_{L} = D [ {G}_{L , In} * F [ {T}_{L , In}^{′} ] ] \qquad Eq . ( 10 )$$

$${S}_{R} = D [ {G}_{R , In} * F [ {T}_{R , In}^{′} ] ] \qquad Eq . ( 11 )$$

where F[ ] is a filter function, and D[ ] is the delay function.

The configurations of the crosstalk cancellation can be determined by the speaker parameters. In one example, filter center frequency, delay amount, amplifier gain, and filter gain can be determined, according to an angle formed between two speakers with respect to a listener (e.g., the listener 140a). In some embodiments, values between the speaker angles are used to interpolate other values. In some embodiments, the perceived “origin” of sound from a speaker may be spatially different from the actual speaker cone, such as may result from orthogonal speaker orientation relative to the listener's head. Here, the configuration of the crosstalk cancellation may be tuned based on the perceived angle, rather than the actual angle of the speakers with respect to the listener.

The combiner 550 combines the right contralateral cancellation component SR to the left in-band channel T_{L,In} to generate a left in-band compensation channel UL, and the combiner 552 combines the left contralateral cancellation component SL to the right in-band channel T_{R,In} to generate a right in-band compensation channel UR. The in-out band combiner 560 combines the left in-band compensation channel UL with the out-of-band channel T_{L,Out} to generate the left output channel O_{L}, and combines the right in-band compensation channel UR with the out-of-band channel T_{R,Out} to generate the right output channel O_{R}.

Accordingly, the left output channel O_{L} includes the right contralateral cancellation component SR corresponding to an inverse of a portion of the in-band channel T_{R,In} attributing to the contralateral sound, and the right output channel O_{R} includes the left contralateral cancellation component SL corresponding to an inverse of a portion of the in-band channel T_{L,In} attributing to the contralateral sound. In this configuration, a wavefront of an ipsilateral sound component output by the speaker 110_{R} according to the right output channel O_{R} arrived at the right ear can cancel a wavefront of a contralateral sound component output by the loudspeaker 110_{L} according to the left output channel O_{L}. Similarly, a wavefront of an ipsilateral sound component output by the speaker 110_{L} according to the left output channel O_{L} arrived at the left ear can cancel a wavefront of a contralateral sound component output by the speaker 110_{R} according to right output channel O_{R}. Thus, contralateral sound components can be reduced to enhance spatial detectability.

Additional details regarding subband spatial processing and crosstalk cancellation are discussed in U.S. patent application Ser. No. 15/409,278, filed Jan. 18, 2017, U.S. patent application Ser. No. 15/404,948, filed Jan. 12, 2017, and U.S. patent Ser. No. 15/646,821, filed Jul. 11, 2017, each incorporated by reference in its entirety.

### Example Audio System Processing

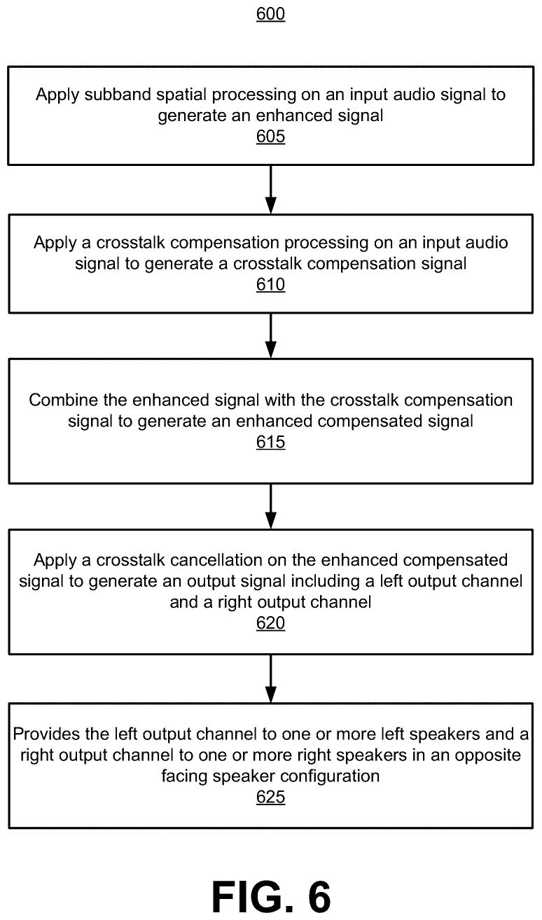

FIG. 6 is a flow chart of a process 600 for performing subband spatial enhancement and crosstalk cancellation on an input audio signal for opposite facing speakers, in accordance with some embodiments. The process 600 is discussed as being performed by the audio processing system 200, although other types of computing devices or circuitry may be used. The process 600 may include fewer or additional steps, and steps may be performed in different orders.

The audio processing system 200 (e.g., subband spatial processor 205) applies 605 a subband spatial processing on an input audio signal X to generate an enhanced signal E. For example, the subband spatial processor 205 applies subband gains to the spatial or side component Xₛ to generate the enhanced spatial component Eₛ, and applies subband gains to the nonspatial or mid component Xₘ to generate the enhanced nonspatial component Eₘ.

The audio processing system 200 (e.g., crosstalk compensation processor 240) applies 610 a crosstalk compensation processing on an input audio signal X to generate a crosstalk compensation signal Z. For example, the crosstalk compensation processor 240 applies filters to the nonspatial component Xₘ of the input channels X_{L}, X_{R}, and applies filters to the spatial component Xₛ of the input channels X_{L}, X_{R}. These filters adjust for spectral defects that may be caused by crosstalk cancellation or other crosstalk processing.

The audio processing system 200 (e.g., combiner 250) combines 615 the enhanced signal E with the crosstalk compensation signal Z to generate an enhanced compensated signal T. The enhanced compensated signal T includes the spatial enhancement of the enhanced signal E, adjusted for the crosstalk cancellation by the crosstalk compensation signal Z.

The audio processing system 200 (e.g., crosstalk cancellation processor 260) applies 620 a crosstalk cancellation on the enhanced compensated signal T to generate an output signal O including a left output channel O_{L} and a right output channel O_{R}. For example, the crosstalk cancellation processor 260 receives the left enhanced compensation channel T_{L} and the right enhanced compensation channel T_{R}. The crosstalk cancellation processor 260 separates the left enhanced compensation channel T_{L} into a left inband signal and a left out-of-band signal, and separates the right enhanced compensation channel T_{R} into a right inband signal and a right out-of-band signal. The crosstalk cancellation processor 260 generates a left crosstalk cancellation component by filtering and time delaying the left inband signal, and generates generate a right crosstalk cancellation component by filtering and time delaying the right inband signal. The crosstalk cancellation processor 260 generates the left output channel O_{L} by combining the right crosstalk cancellation component with the left inband signal and the left out-of-band signal, and generates the right output channel O_{R} by combining the left crosstalk cancellation component with the right inband signal and the right out-of-band signal.

The audio processing system 200 provides 625 the left output channel O_{L} to one or more left speakers and a right output channel O_{R} to one or more right speakers in an opposite facing speaker configuration.

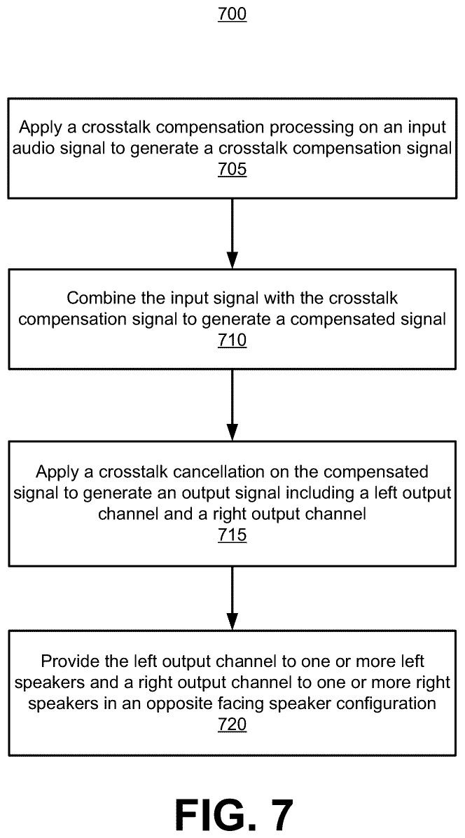

FIG. 7 is a flow chart of a process 700 for performing crosstalk cancellation on an input audio signal for opposite facing speakers, in accordance with some embodiments. The process 700 is discussed as being performed by the audio processing system 200, although other types of computing devices or circuitry may be used. The process 700 may include fewer or additional steps, and steps may be performed in different orders. Unlike the process 600, the process 700 does not include a subband spatial processing.

The audio processing system 200 (e.g., crosstalk compensation processor 240) applies 705 a crosstalk compensation processing on an input audio signal X to generate a crosstalk compensation signal Z.

The audio processing system 200 (e.g., combiner 250) combines 710 the input signal X with the crosstalk compensation signal Z to generate a compensated signal T. Here, the subband spatial processing is not performed to generate the enhanced signal E from the input signal X. Instead, the crosstalk compensation signal Z is combined with the input signal X. The subband spatial processor 205 of the audio processing system 200 may be disabled or operate as a bypass. In some embodiments, the subband spatial processor 205 is omitted from the system 200.

The audio processing system 200 (e.g., crosstalk cancellation processor 260) applies 715 a crosstalk cancellation on the compensation signal T to generate an output signal O including a left output channel O_{L} and a right output channel O_{R}. For example, the crosstalk cancellation processor 270 receives a left compensation channel T_{L} and a right compensation channel T_{R} of the compensation signal T. The crosstalk cancellation processor 260 separates the left compensation channel T_{L} into a left inband signal and a left out-of-band signal, and separates the right compensation channel T_{R} into a right inband signal and a right out-of-band signal. The crosstalk cancellation processor 260 generates a left crosstalk cancellation component by filtering and time delaying the left inband signal, and generates generate a right crosstalk cancellation component by filtering and time delaying the right inband signal. The crosstalk cancellation processor 260 generates the left output channel O_{L} by combining the right crosstalk cancellation component with the left inband signal and the left out-of-band signal, and generates the right output channel O_{R} by combining the left crosstalk cancellation component with the right inband signal and the right out-of-band signal.

The audio processing system 200 provides 720 the left output channel O_{L} to one or more left speakers and a right output channel O_{R} to one or more right speakers in an opposite facing speaker configuration.

### Example Computing System

It is noted that the systems and processes described herein may be embodied in an embedded electronic circuit or electronic system. The systems and processes also may be embodied in a computing system that includes one or more processing systems (e.g., a digital signal processor) and a memory (e.g., programmed read only memory or programmable solid state memory), or some other circuitry such as an application specific integrated circuit (ASIC) or field-programmable gate array (FPGA) circuit.

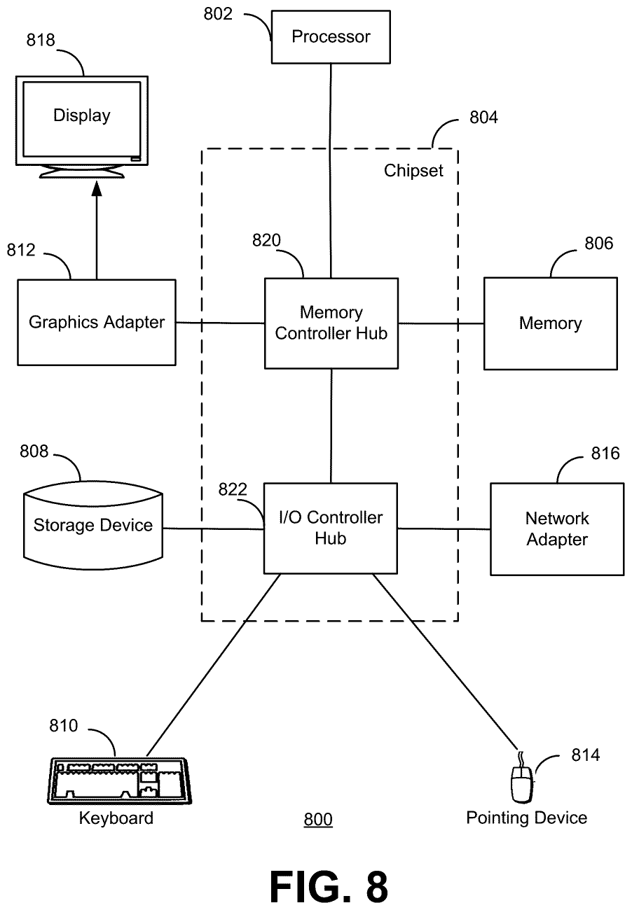

FIG. 8 illustrates an example of a computer system 800, according to one embodiment. The audio processing system 200 may be implemented on the system 800. Illustrated are at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display device 818 is coupled to the graphics adapter 812. A storage device 808, keyboard 810, pointing device 814, and network adapter 816 are coupled to the I/O controller hub 822. Other embodiments of the computer 800 have different architectures. For example, the memory 806 is directly coupled to the processor 802 in some embodiments.

The storage device 808 includes one or more non-transitory computer-readable storage media such as a hard drive, compact disk read-only memory (CD-ROM), DVD, or a solid-state memory device. The memory 806 holds software (or program code) that may be comprised of one or more instructions and data used by the processor 802. For example, the memory 806 may store instructions that when executed by the processor 802 causes or configures the processor 802 to perform the functionality discussed herein, such as the processes 600 and 700. The pointing device 814 is used in combination with the keyboard 810 to input data into the computer system 800. The graphics adapter 812 displays images and other information on the display device 818. In some embodiments, the display device 818 includes a touch screen capability for receiving user input and selections. The network adapter 816 couples the computer system 800 to a network. Some embodiments of the computer 800 have different and/or other components than those shown in FIG. 8. For example, the computer system 800 may be a server that lacks a display device, keyboard, and other components, or may use other types of input devices.

### Additional Considerations

The disclosed configuration may include a number of benefits and/or advantages. For example, an input signal can be output to unmatched loudspeakers while preserving or enhancing a spatial sense of the sound field. A high quality listening experience can be achieved even when the speakers are unmatched or when the listener is not in an ideal listening position relative to the speakers.

Upon reading this disclosure, those of skill in the art will appreciate still additional alternative embodiments the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope described herein.

Any of the steps, operations, or processes described herein may be performed or implemented with one or more hardware or software modules, alone or in combination with other devices. In one embodiment, a software module is implemented with a computer program product comprising a computer readable medium (e.g., non-transitory computer readable medium) containing computer program code, which can be executed by a computer processor for performing any or all of the steps, operations, or processes described.

What is claimed is:

1. A system for audio processing, comprising:
a left speaker and a right speaker addressing inward with respect to each other;
a circuitry configured to:
generate a cross-talk cancelled left output channel and a cross-talk cancelled right output channel based on a left channel and a right channel of an input audio signal; and
provide the left output channel to the left speaker and the right output channel to the right speaker to generate a sound providing a plurality of crosstalk cancelled listening regions that are spaced apart.

2. The system of claim 1, wherein the circuitry is configured to:
generate a left crosstalk cancellation component by filtering a portion of the left channel;
generate a right crosstalk cancellation component by filtering a portion of the right channel;
generate the cross-talk cancelled left output channel by combining the right crosstalk cancellation component with the left channel;
generate the cross-talk cancelled right output channel by combining the left crosstalk cancellation component with the right channel.

3. The system of claim 2, wherein the circuitry is further configured to:
separate the left channel into a left inband signal and a left out-of-band signal, the portion of the left channel including the left inband signal;
separate the right channel into a right inband signal and a right out-of-band signal, the portion of the right channel including the right inband signal;
generate the left crosstalk cancellation component by filtering and time delaying the left inband channel; and
generate the right crosstalk cancellation component by filtering and time delaying the right inband channel.

4. The system of claim 1, wherein the circuitry is further configured to provide the left output channel to another left speaker and the right output channel to another right speaker, wherein:
the left speaker and the other left speaker address outward with respect to each other and form a left speaker pair;
the right speaker and the other right speaker address outward with respect to each other and form a right speaker pair; and
the left speaker pair and right speaker pair are spaced apart.

5. The system of claim 1, wherein the circuitry further comprises a subband spatial processor configured to gain adjust mid subband components and side subband components of the input audio signal.

6. The system of claim 5, wherein each of the side subband components and mid subband components corresponds to a respective frequency band of a group of frequency bands, and wherein at least one frequency band of the group of frequency bands includes a set of critical bands corresponding to a grouping of contiguous Bark scale critical bands.

7. The system of claim 1, wherein the sound includes a monofill region in between a first crosstalk cancelled listening region of the plurality of crosstalk cancelled listening regions and a second crosstalk cancelled listening region of the plurality of crosstalk cancelled listening regions.

8. The system of claim 1, wherein the circuitry further comprises a crosstalk compensation processor configured to:
compensate for crosstalk processing artifacts by applying a plurality of filters to the left channel and the right channel, wherein the crosstalk processing artifacts are produced when generating the cross-talk cancelled left output channel and the cross-talk cancelled right output channel based.

9. The system of claim 8, wherein the crosstalk compensation processor is configured to compensate for the crosstalk processing artifacts through:
application of a plurality of mid filters of the plurality of filters to a plurality of nonspatial components of the left channel and the right channel;
application of a plurality of side filters of the plurality of filters to a plurality of spatial components of the left channel and the right channel;
generation of a left crosstalk compensation channel by summing the plurality of filtered nonspatial components with the plurality of filtered spatial components; and
generation of a right crosstalk compensation channel by subtracting the plurality of filtered spatial components from the plurality of filtered nonspatial components.

10. The system of claim 1, wherein the left speaker and the right speaker addressing inward with respect to each other comprises the left speaker addressing at an angle between 30 degrees and 180 degrees with respect to the right speaker.

11. A non-transitory computer readable medium comprising stored instructions, wherein the stored instructions, when executed by a processor, cause the processor to:
receive an input audio signal comprising a left channel and a right channel; and
generate a cross-talk cancelled left output channel and a cross-talk cancelled right output channel based on the left channel and the right channel; and
provide the left output channel to a left speaker and the right output channel to a right speaker to generate a sound providing a plurality of crosstalk cancelled listening regions that are spaced apart, the left speaker and the right speaker addressing inward with respect to each other.

12. The non-transitory computer readable medium of claim 11, wherein the stored instructions further comprise instructions that, when executed by the processor, cause the processor to:
generate a left crosstalk cancellation component by filtering a portion of the left channel;
generate a right crosstalk cancellation component by filtering a portion of the right channel;
generate the cross-talk cancelled left output channel by combining the right crosstalk cancellation component with the left channel;
generate the cross-talk cancelled right output channel by combining the left crosstalk cancellation component with the right channel.

13. The non-transitory computer readable medium of claim 11, wherein the stored instructions further comprise instructions that, when executed by the processor, cause the processor to provide the left output channel to another left speaker and the right output channel to another right speaker, wherein:
the left speaker and the other left speaker address outward with respect to each other and form a left speaker pair;
the right speaker and the other right speaker address outward with respect to each other and form a right speaker pair; and
the left speaker pair and right speaker pair are spaced apart.

14. The non-transitory computer readable medium of claim 11, wherein the stored instructions further comprise instructions that, when executed by the processor, cause the processor to gain adjust mid subband components and side subband components of the input audio signal.

15. The non-transitory computer readable medium of claim 14, wherein each of the side subband components and mid subband components corresponds to a respective frequency band of a group of frequency bands, and wherein at least one frequency band of the group of frequency bands includes a set of critical bands corresponding to a grouping of contiguous Bark scale critical bands.

16. The non-transitory computer readable medium of claim 11, wherein the sound includes a monofill region in between a first crosstalk cancelled listening region of the plurality of crosstalk cancelled listening regions and a second crosstalk cancelled listening region of the plurality of crosstalk cancelled listening regions.

17. The non-transitory computer readable medium of claim 11, wherein the stored instructions further comprise instructions that, when executed by the processor, cause the processor to compensate for crosstalk processing artifacts by applying a plurality of filters to the left channel and the right channel, wherein the crosstalk processing artifacts are produced when generating the cross-talk cancelled left output channel and the cross-talk cancelled right output channel based.

18. The non-transitory computer readable medium of claim 11, wherein the left speaker and the right speaker addressing inward with respect to each other comprises the left speaker addressing at an angle between 30 degrees and 180 degrees with respect to the right speaker.

19. A method comprising:
receiving an input audio signal comprising a left channel and a right channel; and
generating a cross-talk cancelled left output channel and a cross-talk cancelled right output channel based on the left channel and the right channel; and
providing the left output channel to a left speaker and the right output channel to a right speaker to generate a sound providing a plurality of crosstalk cancelled listening regions that are spaced apart, the left speaker and the right speaker addressing inward with respect to each other.

20. The method of claim 19, further comprising:
generating a left crosstalk cancellation component by filtering a portion of the left channel;
generating a right crosstalk cancellation component by filtering a portion of the right channel;
generating the cross-talk cancelled left output channel by combining the right crosstalk cancellation component with the left channel;
generating the cross-talk cancelled right output channel by combining the left crosstalk cancellation component with the right channel.
